(19) United States
(12) Patent Application Publication
(10) Pub. No.: US 2018/0354438 A1
(43) Pub. Date: Dec. 13, 2018

(54) INFLATABLE PROTECTIVE GUARD FOR A HYBRID VEHICLE BATTERY

(71) Applicant: FORD GLOBAL TECHNOLOGIES, LLC, Dearborn, MI (US)

(72) Inventors: Mohamed Ridha BACCOUCHE, Ann Arbor, MI (US); Rahul ARORA, Birmingham, MI (US); Saeed David BARBAT, Novi, MI (US)

(21) Appl. No.: 15/620,273

(22) Filed: Jun. 12, 2017

(51) Int. Cl. B60R 19/20; B62D 21/15; B62D 27/06; B62D 21/02; B60R 19/34; B62D 25/20; B60K 1/04

(52) U.S. Cl. CPC B60R 19/205; B62D 21/155; B62D 27/065; B62D 21/02; B60Y 2306/01; B62D 25/2009; B60K 1/04; B60K 2001/0438; B60K 2001/0416; B60R 19/34

(57) ABSTRACT

A rear collision guard for a vehicle having a battery disposed on an underbody wall that is supported by longitudinal rails. The guard comprises a pair of sidewalls that attach to the longitudinal rails through the underbody wall and extend longitudinally on right and left lateral sides of the battery. A channel is attached to a back-end of each of the sidewalls and is spaced behind the battery. An airbag is attached to a rearwardly facing surface of the channel and is operatively connected to an inflation system that inflates the airbag to expand rearwardly in a rear end collision.

### TECHNICAL FIELD

This disclosure relates to an inflatable airbag attached to a rear portion of an electric vehicle battery pack, a hybrid vehicle battery pack, or a hybrid vehicle internal combustion engine to protect the battery or engine in a collision with the rear bumper.

### BACKGROUND

A hybrid vehicle traction battery packaged in the rear area of the vehicle body, e.g. in or below the trunk, interferes with the ability of the rear structure of the vehicle to absorb energy from the collision. Vehicles are tested in a 55-mph rear offset crash against a deformable barrier. Interference with energy absorption is caused by either a reduction in the available crash distance due to the battery packaging or a change in the mode of crash. In one crash mode, the rear rails are prevented from hinging due to bolting the battery enclosure to the rear structure energy management components such as rails, cross members, and the like.

This interference with energy absorption could lead to excessively straining the battery enclosure, cracking cells trays, and rupturing the battery cells in the battery of a fully electrified vehicle. In hybrid vehicles having either a battery or an internal combustion engine assembled to the rear portion of the vehicle, a load applied in a rear end collision may be transferred to the battery or the internal combustion engine or its associated components.

This disclosure is directed to solving the above problems and other problems as summarized below.

### SUMMARY

According to one aspect of this disclosure, a rear collision guard is disclosed for a vehicle having a battery disposed on an underbody wall that is supported by longitudinal rails. The guard comprises a pair of sidewalls that attach to the longitudinal rails through the underbody wall and extend longitudinally on right and left lateral sides of the battery. A channel is attached to a back-end of each of the sidewalls and is spaced behind the battery. An airbag is attached to a rearwardly facing surface of the channel and is operatively connected to an inflation system that inflates the airbag to expand rearwardly in a rear end collision.

According to other aspects of this disclosure, the sidewalls may be L-shaped and each sidewall includes a base flange secured to the longitudinal rails and a vertical flange adjacent one of the lateral sides of the battery. Impact forces applied to the airbag are transferred to the channel and are then transferred through the sidewalls to the longitudinal rails.

The vertical flange may be attached to one of the lateral sides of the battery and the vertical flange may be deformed preferentially compared to the base flange to facilitate transferring impact forces applied to the sidewalls through the base flange to the longitudinal rails. The base flange may have a thickness T₁ and the vertical flange may have a thickness T₂, wherein T₂ is less than T₁.

The vehicle includes a rear bumper that is assembled to crush cans that absorb energy in a rear collision to the bumper, and the airbag expands toward the rear bumper in the rear collision.

The channel may have an intermediate wall extending between upper and lower walls, wherein the intermediate wall is attached on opposite lateral ends to the sidewalls.

The sidewalls may each include a base flange secured to the longitudinal rails and a vertical flange adjacent a lateral side of the battery that are joined by a fillet wall extending diagonally between the base flange and the vertical flange. Impact forces applied to the airbag are transferred to the channel and are then transferred through the fillet wall and the base flange to the longitudinal rails.

According to another aspect of this disclosure, a vehicle is disclosed that includes an inflatable airbag system assembled to a rearwardly facing surface of a channel. A pair of longitudinally extending longitudinal rails supports a battery in a rear portion of the vehicle. Right and left sidewalls are assembled to right and left lateral sides of a traction battery. The channel is attached to a rear end of the sidewalls and is rearwardly spaced from the traction battery.

The inflatable airbag system includes a metal airbag, wherein impact forces applied to the metal airbag are transferred to the channel and are then transferred through the sidewalls to the longitudinal rails.

The vehicle includes an underbody wall disposed below the battery and a compartment floor disposed above the battery, wherein the sidewalls are attached to the longitudinal rails through the underbody wall.

The sidewalls are L-shaped and each include a base flange secured to the longitudinal rails and a vertical flange adjacent one of the lateral sides of the battery that are joined by a fillet wall extending diagonally between the base flange and the vertical flange, wherein the inflatable airbag system deploys an airbag with impact forces applied to the airbag being transferred sequentially to the channel, the fillet wall, the base flange, and to the longitudinal rails.

The above aspects of this disclosure and other aspects will be described below with reference to the attached drawings.

### BRIEF DESCRIPTION OF THE DRAWINGS

FIG. 1 is a schematic top plan view of a vehicle that includes a traction battery.

FIG. 2 is a fragmentary view showing the traction battery disposed between the rear wheel housings of the vehicle.

FIG. 3 is a perspective view of a traction battery including a guard assembly enclosing a traction battery.

FIG. 4 is a rear elevation view of a left side wall of the guard assembly.

FIG. 5 is a perspective view of a guard assembly.

FIG. 6 is a perspective view of the guard assembly enclosing a traction battery.

FIG. 7 is fragmentary plan view of one rear corner of the traction battery showing part of the left sidewall and the channel that supports airbag in its uninflated condition.

FIG. 8 is fragmentary side elevation view of the traction battery in relation to a rear seat assembly of a vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

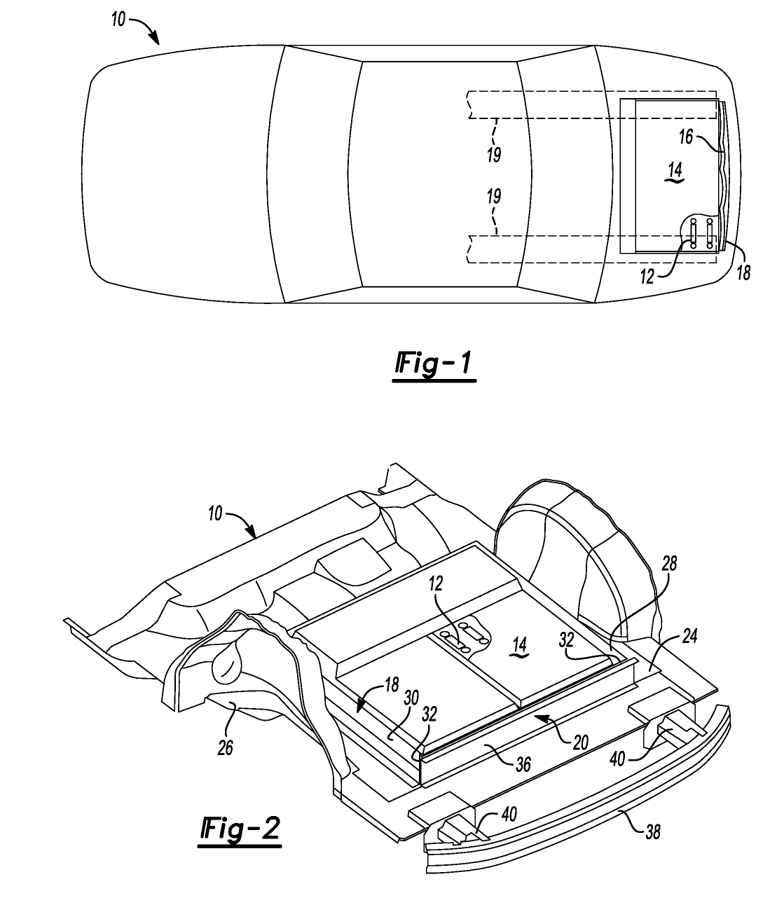

Referring to FIG. 1, a vehicle 10 is diagrammatically illustrated that includes a traction battery 12 beneath the compartment floor 14 in a rear area of the vehicle 10. An airbag 16 is partially housed in a guard assembly 18 that will be more fully described with reference to the following description of FIGS. 2-7 below. The traction battery 12 is supported on a pair of longitudinal rails 19 that may also be referred to as the vehicle frame rails. The longitudinal rails 19 may be independent rails or may be rails formed in a unibody construction method.

Referring to FIG. 2, the vehicle 10 is partially illustrated in a fragmentary view showing the rear portion of the vehicle. The traction battery 12 is disposed below a compartment floor 14 that forms the floor of a trunk or hatch-back area of a vehicle. A guard assembly 18 partially encloses the airbag 16 when the airbag is in its undeployed or uninflated condition.

Referring to FIG. 2, the vehicle 10 is partially illustrated in the rear area where the traction battery 12 is disposed below a compartment floor 14. The guard assembly 18 is shown with the airbag 16 (shown in FIG. 1) removed. Under body wall 24 supports the traction battery 12. A channel, generally indicated by reference numeral 20, is attached to right sidewall 28 and a left sidewall 30. The right and left sidewalls 28 and 30 are L-shaped members that are attached to opposite lateral sides of the traction battery 12. The back ends 32 of the right and left sidewalls 28 and 30 abut a rearwardly facing surface of an intermediate wall 36 of the channel 20, or tray.

A rear bumper 38 is shown at the rear end of the vehicle 10. The rear bumper 38 is supported on a pair of crush cans 40 that are provided to absorb impact energy in a rear-end collision.

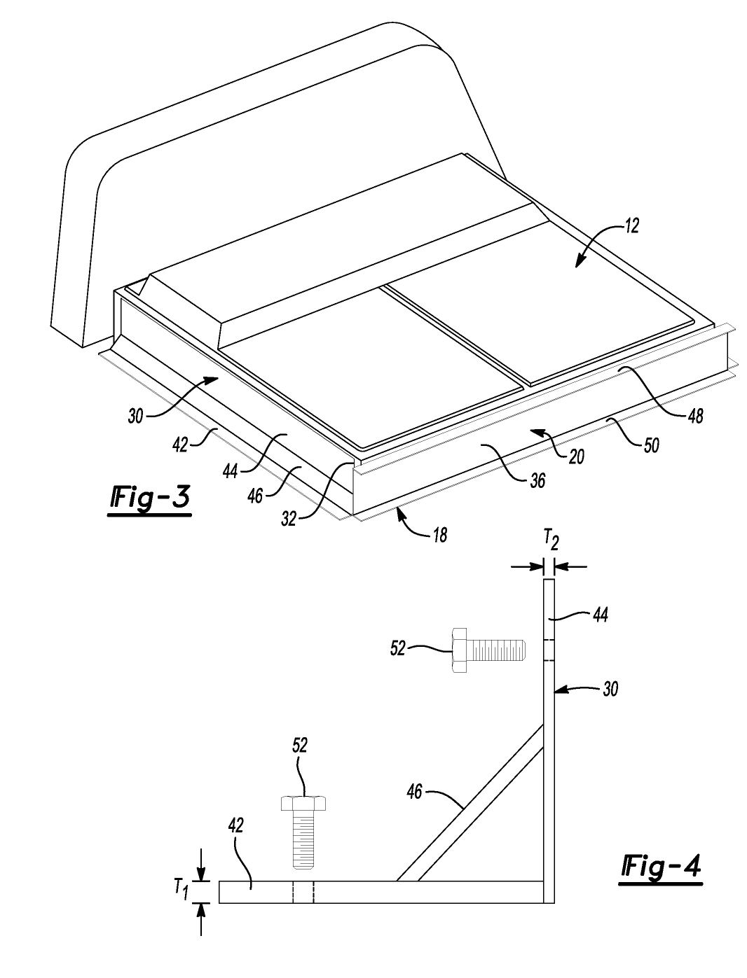

Referring to FIG. 3, the traction battery 12 is shown with a left sidewall 30 in the channel 20 being provided on two sides of the traction battery 12. The left sidewall 30 includes a base flange 42 that is adapted to be attached to the under body wall 24 (shown in FIG. 2). A vertical flange 44 extends upwardly from the base flange 42. A fillet wall 46 extends diagonally between the base flange 42 and vertical flange 44. The channel 20 includes a rearwardly facing wall 36 that is provided with an upper wall 48 on its upper edge and a lower wall 50 on the lower edge of the rearwardly facing wall 36.

Referring to FIG. 4, the left sidewall 30 is shown in isolation. The base flange 42 and vertical flange 44 are shown joined together at right angles with a fillet wall 46 extending between the two flanges 42, 44. Bolts 52, or other fasteners, are shown ready to be inserted into the base flange 42 and vertical flange 44.

The base flange 42 has a thickness T₁ that is greater than the thickness of the vertical flange 44 that has a thickness of T₂. The vertical flange 44 is thinner than the base flange 42 to facilitate movement of the guard assembly 18 (shown in FIGS. 3 and 4) relative to the battery 12. The vertical flange 44 is intended to shear or deform to a limited extent in the event of a rear-end collision. The vertical wall 44 is designed to move relative to the traction battery 12 while much of the force of the rear-end collision is transferred through the base flange 42 and fillet wall 46 to the longitudinal rails 19 (shown in FIG. 1).

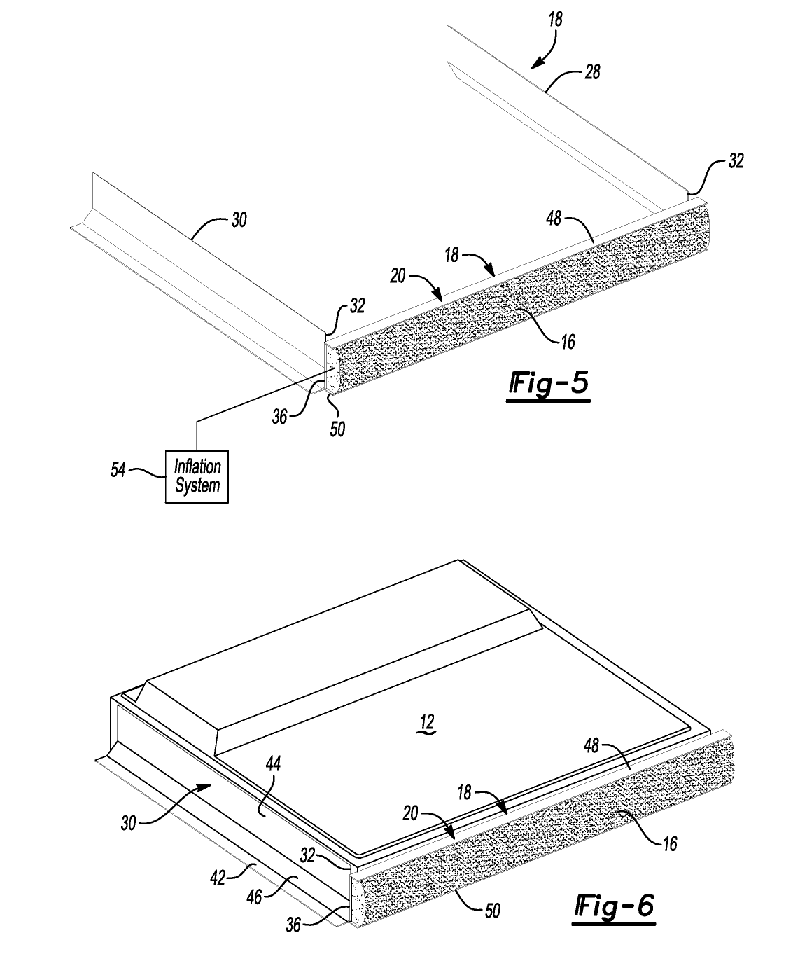

Referring to FIG. 5, the guard assembly, generally indicated by reference numeral 18, is shown to include the channel 20 and the right and left sidewalls 28 and 30 in isolation with the traction battery removed. The airbag 16 is shown disposed within the channel 20, or tray. The rearwardly facing wall 36 is flanked on its upper and lower ends by the upper wall 48 and lower wall 50. An inflation system 54 is shown diagrammatically that is actuated to inflate the airbag 16. The inflation system 54 includes a control and a pyrotechnic inflator that is actuated in the event of a rear-end collision to protect the traction battery 12.

Referring to FIG. 6, the guard assembly 18 is shown disposed around the traction battery 12. The left sidewall 30, shown to include the base flange 42, vertical flange 44 and fillet wall 46 that extend along the left side of the battery 12. The channel 20, or tray, used to contain the airbag 16 is shown to include the rearwardly facing wall 36, upper wall 48 and lower wall 50.

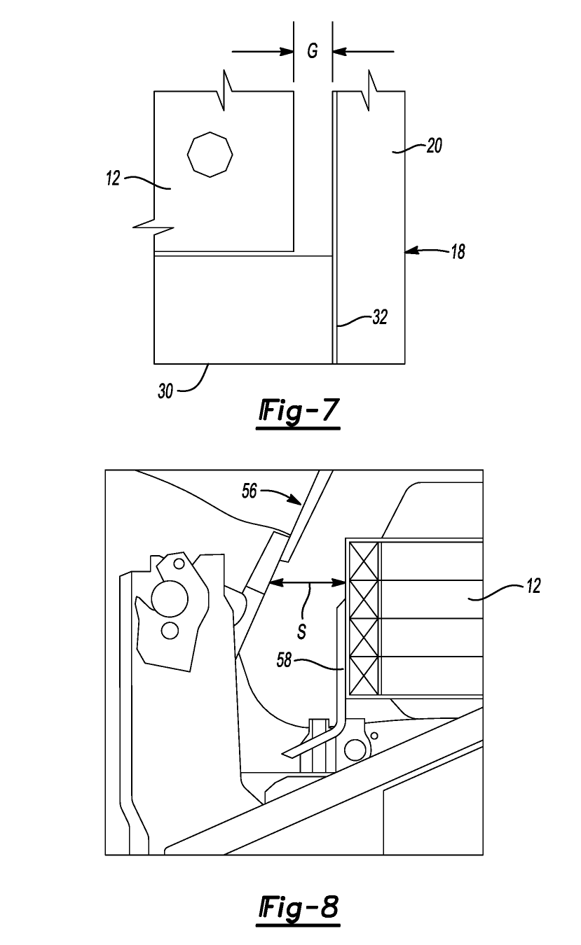

Referring to FIG. 7, a corner of the guard assembly 18 and traction battery 12 is illustrated. The channel 20 of the guard assembly 18 is spaced from the battery 12 as indicated by the arrow G. The channel 20 is attached to a rear, or back end, 32 of the left sidewall 30. In the event of a rear-end collision, the airbag inflates and absorbs impact energy that is in turn transferred to the channel 20. The channel 20 may be initially distorted or deformed into the gap G. Energy is transferred from the channel 20 to the left sidewall 30 (and in like manner to the right sidewall 28). The force of the collision is then transferred from the sidewalls 28, 30 to the longitudinal rails 29. The under body wall 24 supports the traction battery 12 and forces exerted on the guard assembly 18 are transferred through the under body wall 24 to the longitudinal rails 19.

Referring to FIG. 8, the rear seat, generally indicated by reference numeral 56, is shown spaced a distance “S” from the traction battery. A front battery bracket is secured to the vehicle to hold the battery 12 against being displaced in the forward direction in the event of a rear-end collision.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A guard for a vehicle having a battery on an underbody wall supported by longitudinal rails, comprising:
sidewalls attach to the longitudinal rails through the underbody wall and extend longitudinally on right and left lateral sides of the battery;
a channel attached to a back-end of each of the sidewalls is spaced behind the battery;
an airbag attached to a rearwardly facing surface of the channel; and
a system inflates the airbag to expand rearwardly.

2. The guard of claim 1 wherein the sidewalls are L-shaped and each include a base flange secured to the longitudinal rails and a vertical flange adjacent one of the lateral sides of the battery.

3. The guard of claim 2 wherein impact forces applied to the airbag are transferred to the channel and are then transferred through the sidewalls to the longitudinal rails.

4. The guard of claim 2 wherein the base flange has a thickness T1 and the vertical flange has a thickness T2, wherein T2 is less than T1.

5. The guard of claim 4 wherein the vertical flange is attached to one of the lateral sides of the battery and the vertical flange is deformed preferentially compared to the base flange to facilitate transferring impact forces applied to the sidewalls through the base flange to the longitudinal rails.

6. The guard of claim 1 wherein the vehicle includes a rear bumper that is assembled to crush cans that absorb energy in a rear collision to the bumper, and wherein the airbag expands toward the rear bumper in the rear collision.

7. The guard of claim 1 wherein the vehicle includes a compartment floor disposed above the battery.

8. The guard of claim 1 wherein the channel has an intermediate wall extending between upper and lower walls, wherein the intermediate wall is attached on opposite lateral ends to the sidewalls.

9. The guard of claim 1 wherein the sidewalls each include a base flange secured to the longitudinal rails and a vertical flange adjacent a lateral side of the battery that are joined by a fillet wall extending diagonally between the base flange and the vertical flange, wherein impact forces applied to the airbag are transferred to the channel and are then transferred through the fillet wall and the base flange to the longitudinal rails.

10. A vehicle comprising:
a pair of longitudinally extending longitudinal rails;
a battery supported on the longitudinal rails in a rear portion of the vehicle;
right and left sidewalls assembled to right and left lateral sides of a traction battery;
a channel attached to a rear end of the sidewalls, wherein the channel is rearwardly spaced from the traction battery; and
an inflatable airbag system assembled to a rearwardly facing surface of the channel.

11. The vehicle of claim 10 wherein the sidewalls are L-shaped and each include a base flange secured to one of the longitudinal rails and a vertical flange adjacent one of the lateral sides of the battery.

12. The vehicle of claim 11 wherein the inflatable airbag system includes a metal airbag, wherein impact forces applied to the metal airbag are transferred to the channel and are then transferred through the sidewalls to the longitudinal rails.

13. The vehicle of claim 11 wherein the base flange has a thickness T1 and the vertical flange has a thickness T2, wherein T2 is less than T1.

14. The vehicle of claim 13 wherein the vertical flanges are each attached to one of the lateral sides of the battery and the vertical flange is deformed preferentially compared to the base flange to facilitate transferring impact forces applied to the sidewalls through the base flange to the longitudinal rails.

15. The vehicle of claim 10 wherein the vehicle includes a rear bumper that is assembled to crush cans that absorb energy in a rear collision with the rear bumper, wherein the inflatable airbag system deploys an airbag, and wherein the airbag expands toward the rear bumper in the rear collision.

16. The vehicle of claim 10 wherein the vehicle includes an underbody wall disposed below the battery and a compartment floor disposed above the battery, wherein the sidewalls are attached to the longitudinal rails through the underbody wall.

17. The vehicle of claim 10 wherein the channel is a channel having an intermediate wall extending between upper and lower walls, wherein the channel is attached on opposite lateral ends to the sidewalls.

18. The vehicle of claim 10 wherein the sidewalls are L-shaped and each include a base flange secured to the longitudinal rails and a vertical flange adjacent one of the lateral sides of the battery that are joined by a fillet wall extending diagonally between the base flange and the vertical flange, wherein the inflatable airbag system deploys an airbag with impact forces applied to the airbag being transferred sequentially to the channel, the fillet wall, the base flange, and to the longitudinal rails.

19. A traction motor battery assembly comprising:
a traction motor battery;
a battery enclosure enclosing the traction motor battery and being adapted to be assembled in a rear portion of a vehicle and spaced from the rear bumper; and
an airbag attached to a rear-facing surface of the battery enclosure and spaced from the battery, wherein the airbag is inflated by an inflation system in a rear end collision.
